(19) United States
(12) Patent Application Publication
(10) Pub. No.: US 2013/0073220 A1
(43) Pub. Date: Mar. 21, 2013

(54) CONCENTRATION MEASUREMENT METHOD AND CONCENTRATION MEASUREMENT APPARATUS

(71) Applicants: Kazuhiro NISHIDA, Matsumoto-shi (JP); Kazuhiko AMANO, Tokyo (JP); Koichi SHIMIZU, Sapporo-shi (JP)

(72) Inventors: Kazuhiro NISHIDA, Matsumoto-shi (JP); Kazuhiko AMANO, Tokyo (JP); Koichi SHIMIZU, Sapporo-shi (JP)

(73) Assignees: NATIONAL UNIVERSITY CORPORATION HOKKAIDO UNIVERSITY, Sapporo-shi (JP); SEIKO EPSON CORPORATION, Tokyo (JP)

(21) Appl. No.: 13/614,566

(22) Filed: Sep. 13, 2012

(30) Foreign Application Priority Data
Sep. 16, 2011 (JP) 2011-203102

(51) Int. Cl. G06F 19/00; G01N 21/25

(52) U.S. Cl. 702/25

(57) ABSTRACT

A concentration measurement method of measuring at least including processes of: causing a set of lights having first and second different wavelengths in which change amounts of absorption coefficients of the water due to a change in water temperature are substantially the same to be incident on the solution, and measuring an absorption coefficient in the first wavelength and a absorption coefficient in the second wavelength in the solution; referencing an absorption coefficient of the water in the first wavelength and an absorption coefficient of the water in the second wavelength; referencing an absorption coefficient of the solute in the first wavelength and an absorption coefficient of the solute in the second wavelength; and applying a simultaneous equation to obtain a volume fraction of an unknown solute and a volume fraction of the water based on the above absorption coefficients.

### BACKGROUND

1. Technical Field

The present invention relates to a concentration measurement method and a concentration measurement apparatus for noninvasively and accurately measuring a concentration of a target component in an observation target containing a plurality of light-scattering medium layers.

This application claims priority to and the benefits of Japanese Patent Application No. 2011-203102 filed on Sep. 16, 2011, the disclosure of which being incorporated herein by reference.

2. Related Art

In recent years, the number of diabetics has continued to increase each year. Therefore, the number of diabetics with nephritis has also continued to increase each year. As a result, patients suffering from chronic renal insufficiency have also continued to increase by as many as ten thousand each year, and currently number over 280,000.

With the advent of an aging society, the demand for preventive medicine is increasing. Accordingly, the importance of personal metabolism management is rapidly increasing. In metabolism management, a blood sugar value measurement in which reaction of glucose metabolism can be recognized by measuring preprandial and postprandial blood sugar values is known. Evaluation of the reaction of glucose metabolism in an early stage of diabetes enables early treatment based on early diagnosis of the diabetes.

Traditionally, the measurement of the blood sugar value is performed by taking a blood sample from a vein of, for example, an arm or a fingertip and measuring enzyme activity for glucose in the blood. However, this method of measuring a blood sugar value has various problems, such blood sampling being complicated and painful, and posing a risk of infection.

As a method of continuously measuring a blood sugar value, equipment for continuously performing measurement of glucose corresponding to a blood sugar value in a state in which an injection needle is pushed into a vein has been developed in the USA and is currently in clinical trials. However, since the injection needle is pushed into the vein, there are risks of the needle remaining or causing infection during measurement of the blood sugar value.

There is a need for a blood sugar value measurement apparatus capable of frequently measuring a blood sugar value without taking a blood sample and having no risk of infection. Further, there is a need for a miniaturized blood sugar value measurement apparatus capable of being mounted simply and at any time.

An apparatus based on a general principle of spectroscopic analysis measurement using a principle of molecular absorption has been proposed as an apparatus for noninvasively measuring a component concentration.

In a steam apparatus, light having a specific wavelength or continuous light is irradiated to a measurement target, and concentrations of components are calculated based on the Beer-Lambert law using a light absorption amount of the measurement target.

However, in an apparatus for calculating a concentration of glucose based on the above Beer-Lambert law, a light absorption amount is changed according to a temperature change of a measurement target. Accordingly, if the temperature of the measurement target is not in a prescribed temperature range, accurate measurement cannot be performed. For example, when glucose in the blood is measured, a change in the temperature of a solution of glucose and water (moisture) contained in the blood, for example, due to a change in body temperature makes it difficult to accurately measure the concentration of such components.

Further, there is an apparatus that does not use the above-described Beer-Lambert law. A calibration curve is produced using a sample in which a concentration of a material, which is a measurement target, has been determined in advance, and a light absorption amount obtained through measurement of a measured target whose concentration is unknown is compared with the calibration curve. Thus, there is also a measurement apparatus for obtaining a concentration of the measured target (e.g., see JP-A-52-63397 and Japanese Patent No. 3903147).

### SUMMARY

However, even in the measurement apparatus using the above calibration curve, when there is a difference between a sample temperature when the calibration curve is produced and the temperature of the measurement target, the light absorption amount of the component of the measurement target is changed. Accordingly, a measurement error increases. As a result, an accurate concentration of a solute cannot be obtained.

Among measurement apparatuses using the above calibration curve, there is an apparatus using multivariate analysis in consideration of concentration changes of a number of components (e.g., see JP-A-2003-050200 and JP-A-2007-259967).

In a measurement apparatus (a measurement method) using the multivariate analysis, a calibration curve is created through simulation, and a temperature change of a measurement target or interaction between components is not considered. Accordingly, when there is a temperature change of a measurement target or when a plurality of components are contained in the measurement target, an error increases at the time of concentration measurement. As a result, it is difficult to accurately measure a target component.

Further, actually measuring a number of samples without using simulation and creating the calibration curve based on a light absorption amount resulting from the actual measurement may be considered. However, production of the calibration curve in consideration of the above interaction is not practical since it takes a great deal of time and effort.

An advantage of some aspects of the invention is to provide a concentration measurement method and a concentration measurement apparatus capable of accurately measuring a concentration of a solute based on a Beer-Lambert law even when there is a temperature change in a measurement target.

According to a first aspect of the present invention, the invention adopts the following concentration measurement method and concentration measurement apparatus.

A concentration measurement method according to the first aspect of the invention is a concentration measurement method of measuring, using absorptiometry, a concentration of a solute in a solution prepared by dissolving the solute in water that is a solvent, and at least includes processes of:

causing a set of lights having first and second different wavelengths in which change amounts of absorption coefficients of the water due to a change in water temperature are substantially the same to be incident on the solution, and measuring an absorption coefficient (μₐ(λ1)) in the first wavelength and an absorption coefficient (μₐ(λ2)) in the second wavelength in the solution;

referencing an absorption coefficient (μ_{aw}(λ1)) of the water in the first wavelength and an absorption coefficient (μ_{aw}(λ2)) of the water in the second wavelength;

referencing an absorption coefficient (μ_{ag}(λ1)) of the solute in the first wavelength and an absorption coefficient (μ_{ag}(λ2)) of the solute in the second wavelength; and

applying a simultaneous equation (Equation 1 and Equation 2) to obtain a volume fraction (V_{g}1) of an unknown solute and a volume fraction (V_{w}1) of the water based on the absorption coefficients (μₐ(λ1), μₐ(λ2), μ_{aw}(λ1), μ_{aw}(λ2), μ_{ag}(λ1), and μ_{ag}(λ2)).

μₐ(λ1)−μₐ(λ2)=(μ_{aw}(λ1)−μ_{aw}(λ2))V_{w}+(μ_{ag}(λ1)−μ_{ag}(λ2))V_{g} (Equation 1)

V_{g}1+V_{w}1=1 (Equation 2)

The concentration measurement method further includes a pr measuring an absorption coefficient (μₐ(λ3)) of the solution in a third wavelength in which the change amount of the absorption coefficient of the water due to the change in the water temperature is substantially zero, using light having the third wavelength,

wherein an absorption coefficient (μ_{aw}(λ3)) of the water in the third wavelength and an absorption coefficient (μ_{ag}(λ3)) of the solute in the third wavelength are applied together to Equation 3 and a simultaneous equation is formed using any of Equation 3, Equation 1 and Equation 2 to obtain a volume fraction (V_{g}1) of the unknown solute and a volume fraction (V_{w}1) of the water.

μₐ(λ3)=(μ_{aw}(λ3)×V_{w}1)+(μ_{ag}(λ3)×V_{g}1) (Equation 3)

According to a second aspect of the invention, the invention is a concentration measurement method of measuring, using absorptiometry, a concentration of a solute in a solution prepared by dissolving the solute in water that is a solvent, and at least includes processes of:

causing a set of lights having fourth and fifth different wavelengths in which absolute values of change amounts of absorption coefficients of the water due to a change in water temperature are substantially the same and the change amounts have opposite, i.e., positive and negative, signs, to be incident on the solution and measuring an absorption coefficient (μₐ(λ4)) in the fourth wavelength and an absorption coefficient (μₐ(λ6)) in the fifth wavelength in the solution;

referencing an absorption coefficient (μ_{aw}(λ4)) of the water in the fourth wavelength and an absorption coefficient (μ_{aw}(λ5)) of the water in the fifth wavelength;

referencing an absorption coefficient (μ_{ag}(λ4)) of the solute in the fourth wavelength and an absorption coefficient (μ_{ag}(λ5)) of the solute in the fifth wavelength; and

applying a simultaneous equation (Equation 4 and Equation 5) to obtain a volume fraction (V_{g}2) of an unknown solute and a volume fraction (V_{w}2) of the water based on the absorption coefficients (μₐ(λ4), μₐ(λ5), μ_{aw}(λ4), μ_{aw}(λ5), μ_{ag}(λ4), and μ_{ag}(λ5)).

μₐ(λ4)+μₐ(λ5)=(μ_{aw}(λ4)+μ_{aw}(λ5))V_{w}2+(μ_{ag}(λ4)+μ_{ag}(λ5))V_{g}2 (Equation 4)

V_{g}2+V_{w}2=1 (Equation 5)

The concentration measurement method further includes a process of:

measuring an absorption coefficient (μₐ(λ6)) of the solution in a sixth wavelength in which the change (Equation 5) absorption coefficient of the water due to the change in the water temperature is substantially zero, using light having the sixth wavelength,

wherein an absorption coefficient (μ_{aw}(λ6)) of the water in the sixth wavelength and an absorption coefficient (μ_{ag}(λ6)) of the solute in the sixth wavelength are applied together to Equation 6 and a simultaneous equation is formed using any of Equation 6, Equation 4 and Equation 5 to obtain a volume fraction (V_{g}2) of the unknown solute and a volume fraction (V_{w}2) of the water.

μₐ(λ6)=(μ_{aw}(λ6)×V_{w}2)+(μ_{ag}(λ6)×V_{g}2) (Equation 6)

According to a third aspect of the invention, the invention is a concentration measurement apparatus for measuring, using absorptiometry, a concentration of a solute in a solution prepared by dissolving the solute in water that is a solvent, and at least includes:

a light source capable of irradiating a set of lights having seventh and eighth different wavelengths in which change amounts of absorption coefficients of the water due to a change in water temperature are substantially the same;

a storage unit for storing an absorption coefficient (μ_{aw}(λ7)) of the water in the seventh wavelength, an absorption coefficient (μ_{aw}(λ8)) of the water in the eighth wavelength, an absorption coefficient (μ_{ag}(λ7)) of the solute in the seventh wavelength, and an absorption coefficient (λ_{aw}(λ8)) of the solute in the eighth wavelength; and

a calculation unit for calculating a volume fraction (V_{g}3) of the solute and a volume fraction (V_{w}3) of the water in the solution based on the absorption coefficients (μ_{aw}(λ7), μ_{aw}(λ8), μ_{ag}(λ7), and μ_{ag}(λ8)).

The seventh wavelength ranges from 1440 to 1480 nm, and the eighth wavelength ranges from 1500 to 1800 nm.

The light source is further capable of irradiating light having a ninth wavelength in which the change amount of the absorption coefficient of the water due to the change in the water temperature is substantially zero.

The ninth wavelength is any one of wavelength regions of 1789±10 nm, 1440±10 nm, and 1000 to 1300 nm.

The light source includes a spectroscopic means for dividing light having a plurality of wavelengths into at least the light having the seventh wavelength and the light having the eighth wavelength.

A concentration measurement apparatus according to a fourth aspect of the invention is a concentration measurement apparatus for measuring, using absorptiometry, a concentration of a solute in a solution prepared by dissolving the solute in water that is a solvent, and at least includes:

a light source capable of irradiating a set of lights having tenth and eleventh different wavelengths in which change amounts of absorption coefficients of the water due to a change in water temperature are substantially the same and the change amounts have opposite, i.e., positive and negative, signs;

a storage unit for storing an absorption coefficient (μ_{aw}(λ10)) of the water in the tenth wavelength, an absorption coefficient (μ_{aw}(λ11)) of the water in the eleventh wavelength, an absorption coefficient (μ_{ag}(λ10)) of the solute in the tenth wavelength, and an absorption coefficient (μ_{ag}(λ11)) of the solute in the eleventh wavelength; and

a calculation unit for calculating a volume fraction (V_{g}4) of the solute and a volume fraction (V_{w}4) of the water in the solution based on the absorption coefficients (μ_{aw}(λ10), μ_{aw}(λ11), μ_{ag}(λ10), and μ_{ag}(λ11)).

The tenth wavelength ranges from 1440 to 1480 nm and the eleventh wavelength ranges from 1500 to 1800 nm.

The light source is further capable of irradiating light having a twelfth wavelength in which the change amount of the absorption coefficient of the water due to the change in the water temperature is substantially zero.

The twelfth wavelength is any one of wavelength regions of 1789±10 nm, 1440±10 nm, and 1000 to 1300 nm.

The light source includes a spectroscopic means for dividing light having a plurality of wavelengths into at least the light having the tenth wavelength and the light having the eleventh wavelength.

The solute is glucose, and the solution is a glucose solution.

### BRIEF DESCRIPTION OF THE DRAWINGS

FIG. 1 is a schematic block diagram showing a configuration of a concentration measurement apparatus of an embodiment of the invention;

FIG. 2 is a flowchart showing an operation in which the concentration measurement apparatus of the invention measures a concentration of a sample;

FIG. 3 is a schematic diagram schematically showing a state of a glucose solution;

FIG. 4 is a flowchart showing a concentration measurement method of another embodiment of the invention;

FIG. 5 is a flowchart showing a concentration measurement method of another embodiment of the invention;

FIG. 6 is a block diagram showing a concentration measurement apparatus of another embodiment of the invention;

FIG. 7 is a block diagram showing a concentration measurement apparatus of another embodiment of the invention;

FIG. 8 is a graph showing an absorption coefficient spectrum; and

FIG. 9 is a graph showing an absorption coefficient change according to a temperature of ultrapure water.

### DESCRIPTION OF EXEMPLARY EMBODIMENTS

The concentration measurement apparatus and the concentration measurement method of the invention will be described. Further, the present embodiment is an example for better understanding of the scope and spirit of the invention. It does not limit the invention unless particularly mentioned otherwise. Further, in the drawings used in the following description, primary parts are enlarged for better understanding of the invention, but, for example, dimensions of respective components are not the same as real dimensions.

Hereinafter, First Embodiment of the invention will be described.

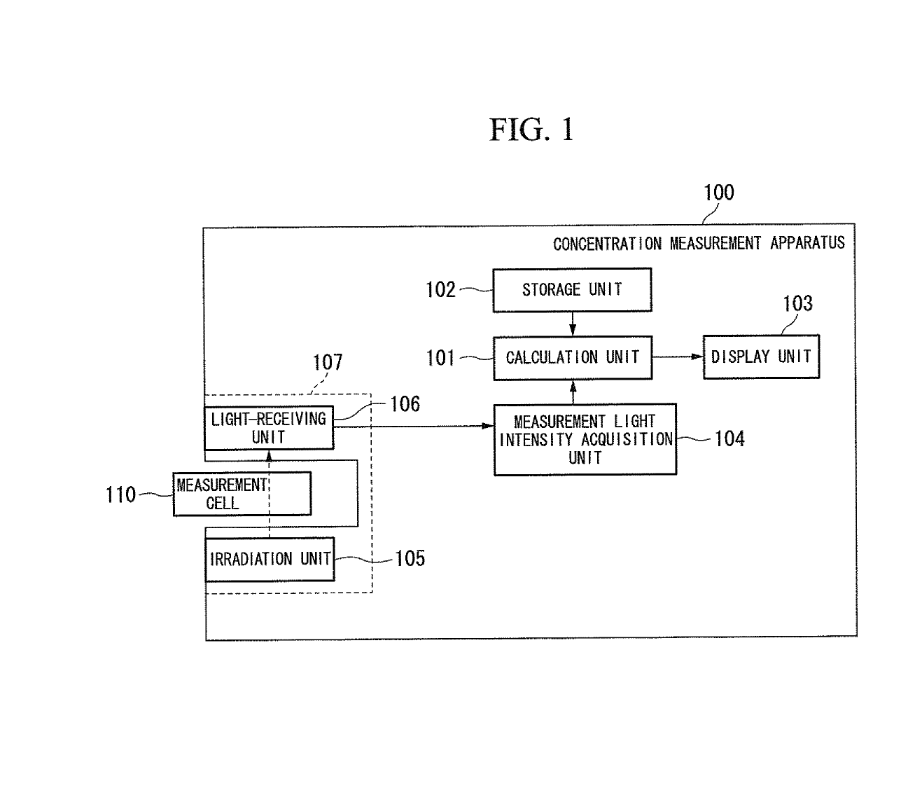

FIG. 1 is a schematic block diagram showing a configuration of a concentration measurement apparatus in a first embodiment of the invention. Using absorptiometry, a concentration measurement apparatus 100 can accurately measure a concentration of a first solute in a solution in which the first solute has been dissolved. The concentration measurement apparatus 100 includes a calculation unit 101, a storage unit 102, a display unit 103, a measurement light intensity acquisition unit (a measurement unit) 104, and a measurement unit 107 including an irradiation unit 105 and a light-receiving unit 106.

The concentration measurement apparatus 100 measures, for example, a concentration of the first solute dissolved in water (a solvent) that is a solvent, whose representative example is liquid equivalent to body fluid (sample: solution) present in a dermis (an arbitrary layer) of skin (an observation target). The concentration measurement apparatus 100 can measure (determine), for example, a concentration of glucose as the first solute. Hereinafter, the glucose as an example of the first solute and liquid equivalent to the body fluid as a measurement target are illustrated.

The invention may be applied to a solution in which interaction occurs, for example, between the water (solvent) and the glucose. Examples of the interaction may include an action according to formation of a cluster generated when the solute is dissolved in the solvent, such as a change in the number of hydrogen bonds between molecules, a hydrogen bond of water and glucose in a glucose solution, or ion binding of water and sodium chloride.

The storage unit 102 stores an absorption coefficient (μ_{aw}(λ)) of the water (the solvent), and an apparent absorption coefficient (μ′_{ag}(λ)) of glucose (the first solute) measured from a solution, in the concentration of the known glucose, in which the glucose has been dissolved in the water.

The measurement light intensity acquisition unit (the measurement unit) 104 measures an absorption coefficient (μₐ(λ)) of a first sample in which a concentration of the glucose is unknown, that is, body fluid present in a dermis (an arbitrary layer) of skin (an observation target).

The irradiation unit (the light source) 105, which is the light source, irradiates light having a predetermined wavelength toward the skin (the observation target). The irradiation unit (the light source) 105 may include, for example, a laser light source.

The irradiation unit 105 irradiates the light to a glass cell 110 into which a sample (the liquid equivalent to the body fluid), which is the measurement target, has been put.

The calculation unit 101 calculates a volume fraction (V_{g}) of unknown glucose and a volume fraction (V_{w}) of the solvent based on the absorption coefficient (μ_{aw}(λ)) of the water (the solvent), the apparent absorption coefficient (μ′_{ag}(λ)) of the known glucose, and the absorption coefficient (μₐ(λ)) of the observation target having an unknown glucose concentration. The calculation unit 101 may include, for example, a CPU and a memory.

The light-receiving unit 106 may receive, for example, the light transmitted through the glass cell 110.

Next, an operation of the concentration measurement apparatus 100, that is, the concentration measurement method of the present embodiment, will be described.

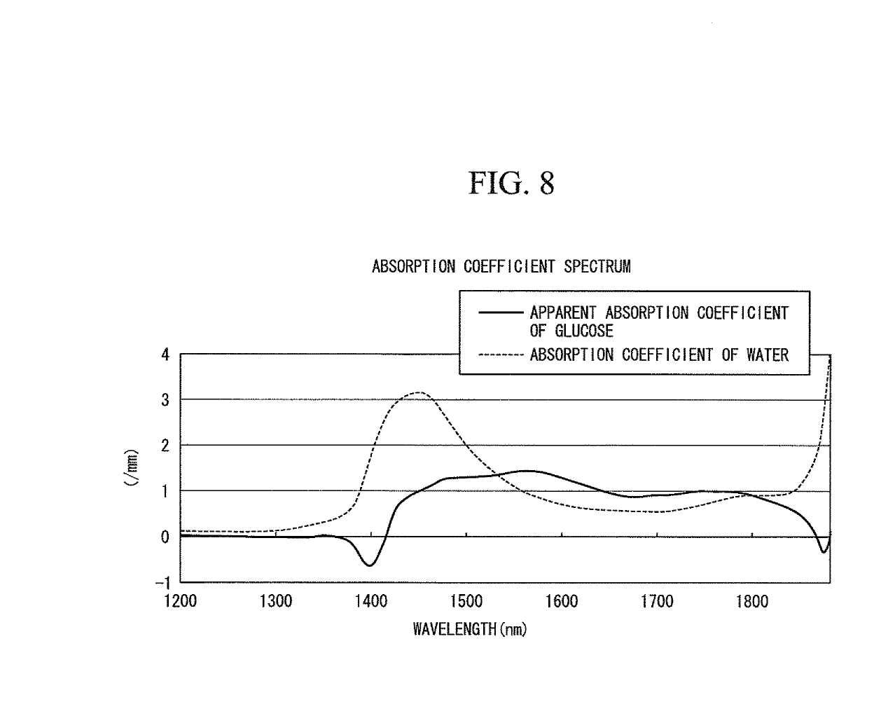

The concentration measurement apparatus 100 produces a solution in which a glucose concentration is known by dissolving a predetermined amount of glucose (a first solute) in water (solvent) in advance before performing measurement, calculates the apparent absorption coefficient (μ′_{ag}(λ)) of the glucose from a measurement value of an absorption coefficient in this solution, and stores the apparent absorption coefficient in the storage unit 102. Further, FIG. 8 shows an example of the apparent absorption coefficient (μ′_{ag}(λ)) of the glucose (the first solute) and the absorption coefficient (μ_{aw}(λ)) of the water (the solvent).

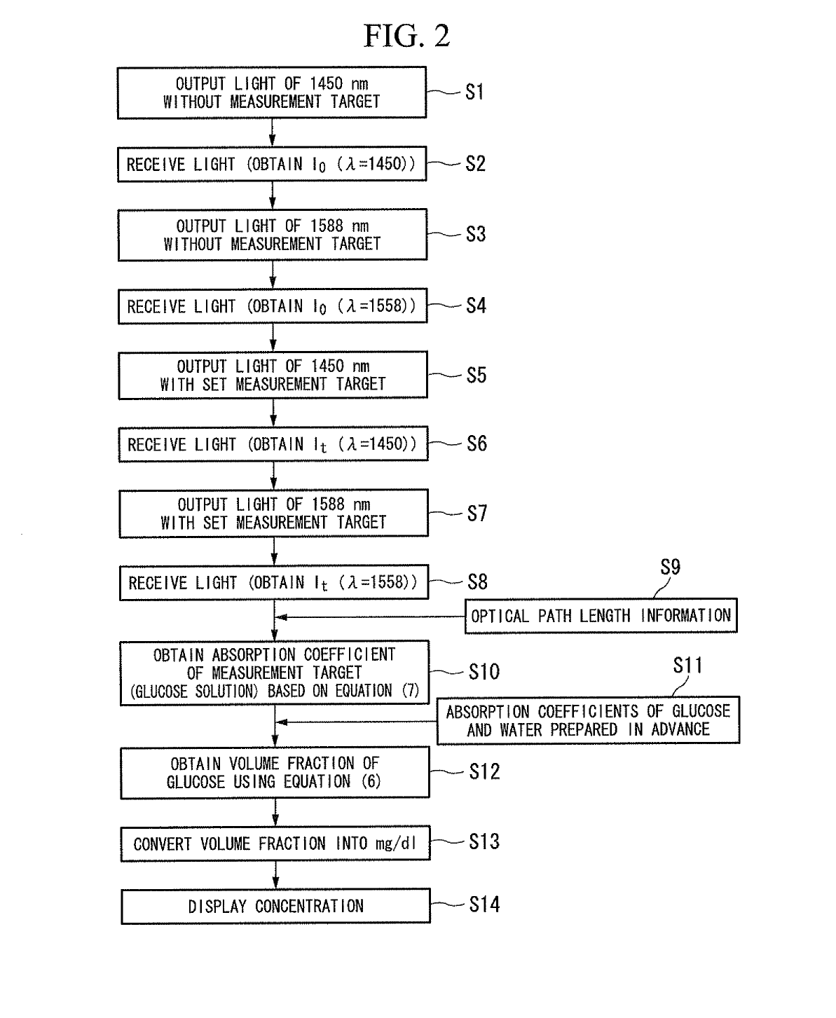

FIG. 2 is a flowchart showing an operation when the concentration of the solute is measured using the concentration measurement apparatus.

First, a measurer operates the concentration measurement apparatus 100. Next, light having a first wavelength (e.g., light of 1450 nm) is output from the irradiation unit (the light source) 105 in a state in which the sample is not put into the glass cell 110 (S1).

When the irradiation unit 105 irradiates the light having the first wavelength (1450 nm), the light-receiving unit 106 receives (measures) the light irradiated from the irradiation unit 105, and obtains a light intensity I₀ (S2).

Next, light having a second wavelength, for example, light of 1588 nm, is output from the irradiation unit (the light source) 105 in a state in which the sample has been put into the glass cell 110 (S3).

When the irradiation unit 105 irradiates the light having the second wavelength (1588 nm), the light-receiving unit 106 receives (measures) the light irradiated from the irradiation unit 105 and obtains a light intensity I₀ (S4).

Next, the light having the first wavelength (e.g., the light of 1450 nm) is output from the irradiation unit (the light source) 105 in a state in which the sample (the liquid equivalent to the body fluid) has been put into the glass cell 110 (S5).

When the irradiation unit 105 irradiates the light having the first wavelength (1450 nm), the light-receiving unit 106 receives (measures) the light irradiated from the irradiation unit 105 and obtains a light intensity Iₜ (S6).

Next, the light having the second wavelength (e.g., the light having of 1588 to 0 nm) is output from the irradiation unit (the light source) 105 in a state in which the sample (the liquid equivalent to the body fluid) has been put into the glass cell 110 (S7).

When the irradiation unit 105 irradiates the light having the first wavelength (1588 nm), the light-receiving unit 106 receives (measures) the light irradiated from the irradiation unit 105, and obtains a light intensity Iₜ (S8).

Next, an optical path length is acquired from optical path length information of the wavelength stored in the storage unit 102 (S9). The calculation unit 101 calculates the absorption coefficient of the sample based on Equation 7 (S10).

$$- ln ( \frac{{I}_{t} ( λ )}{{I}_{o} ( λ )} ) = {μ}_{a} ( λ ) \cdot d \qquad ( Equation 7 )$$

The calculation unit 101 obtains the absorption coefficient (μ_{aw}(λ)) of the water (the solvent) and the apparent absorption coefficient (μ′_{ag}(λ)) of the glucose in the body fluid by referencing the information (advance preparation) stored in the storage unit 102 in advance (S11).

The following Equation 8 is applied to obtain a volume fraction (V_{g}) of the glucose (the first solute) and a volume fraction (V_{w}) of the water (the solvent) in the body fluid of the skin based on the referenced absorption coefficient (μ_{aw}(λ)) of the water, the apparent absorption coefficient (μ′_{ag}(λ) of the glucose, and the measured absorption coefficient (μₐ(λ)) for the wavelengths (λ1), (λ2) . . . of the light irradiated to the skin at the time of measurement (S12).

$${V}_{g} = \frac{\begin{matrix}\{ {μ}_{a} ( 1588 ) - {μ}_{a} ( 1450 ) \} - \\ \{ {μ}_{aw} ( 1588 ) - {μ}_{aw} ( 1450 ) \}\end{matrix}}{\begin{matrix}\{ {μ}_{ag} ( 1588 ) - {μ}_{ag} ( 1450 ) \} - \\ \{ {μ}_{aw} ( 1588 ) - {μ}_{aw} ( 1450 ) \}\end{matrix}} \qquad ( Equation 8 )$$

The obtained volume fraction (V_{g}) is converted into mg/dl (S13). The concentration of the glucose (the first solute) obtained by the above method may be output to the display unit 103 (e.g., a monitor screen or a printer) (S14).

Next, the apparent absorption coefficient of the glucose (the first solute) will be described. The apparent absorption coefficient is a value indicating an absorption characteristic of the solute and contains interaction with the solvent, for example, water. The apparent absorption coefficient of the glucose will be described, for example, in connection with a glucose solution.

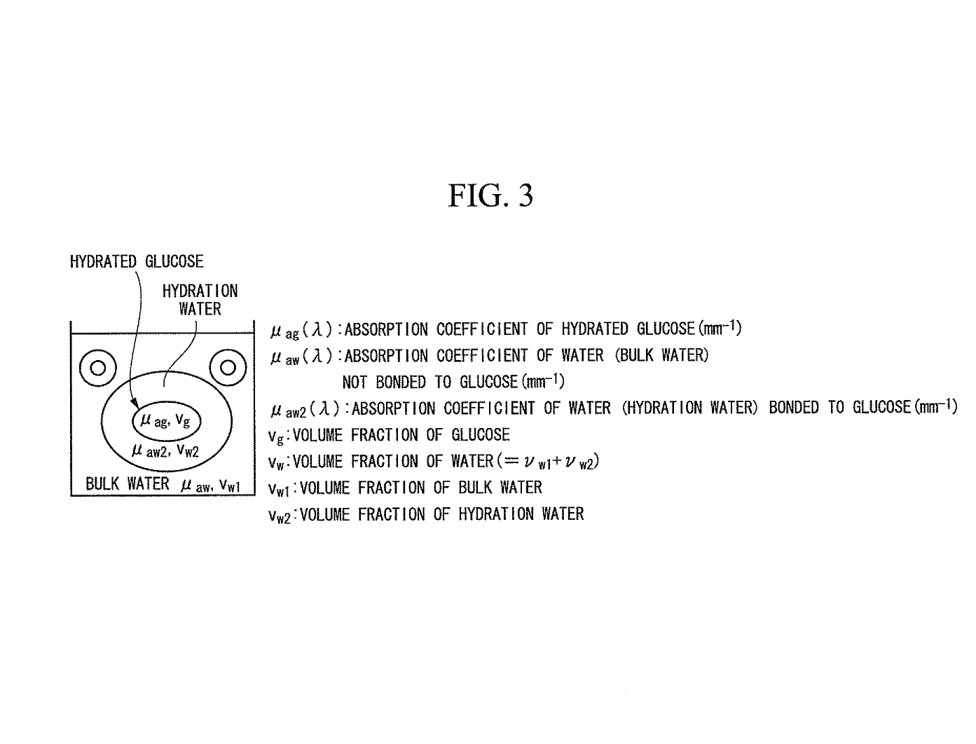

FIG. 3 is a schematic diagram schematically showing a state of the glucose solution.

Components in the glucose solution include two components: glucose and water. In the solution, the glucose and the water are considered to interact with each other through hydrogen bonds. When the water is sufficiently more than the glucose as in the glucose solution equivalent to a blood sugar value, the entire glucose is considered to be influenced by the hydrogen bonds and the water is considered to be partially influenced by the hydrogen bonds. Therefore, for the water, water (bulk water) not bonded to water bonded to the glucose (hydration water) is considered to be a separate component. According to this consideration, the absorption coefficient of the glucose solution may be represented as Equation (9).

μₐ(λ)=μ_{ag}(λ)v_{g}+μ_{aw}(λ))v_{w1}+μ_{aw2}(λ)v_{w2} (Equation 9)

The number of hydrogen bonds is considered to depend on an amount of the glucose. Further, if a sum of v_{w1} and v_{w2} is v_{w}, Equation (9) may be converted into Equation (10) using a proportionality constant α.

$$\begin{matrix}{μ}_{a} ( λ ) = {μ}_{ag} ( λ ) {v}_{g} + {μ}_{aw} ( λ ) ( {v}_{w} - {v}_{w} 2 ) + {μ}_{aw} 2 ( λ ) {v}_{w 2} \\ = {μ}_{ag} ( λ ) {v}_{g} + {μ}_{aw} ( λ ) ( {v}_{w} - α {v}_{g} ) + {μ}_{aw 2} ( λ ) α {v}_{g} \\ = [ {μ}_{ag} ( λ ) + α \{ {μ}_{aw 2} ( λ ) - {μ}_{aw} ( λ ) \} ] {v}_{g} + {μ}_{aw} ( λ ) {v}_{w} \\ = {μ}_{ag}^{′} ( λ ) {v}_{g} + {μ}_{aw} ( λ ) {v}_{w}\end{matrix} \qquad ( Equation 10 )$$

If the contents of [ ] in Equation (10) are μ′_{ag}(λ), a Beer-Lambert law is obtained apparently. μ′_{ag}(λ) is an apparent absorption coefficient and represents a sum of “the absorption coefficient μ_{ag}(λ) of the glucose dissolved in the water” and “a change amount of the absorption coefficient of the water according to glucose addition, μ_{aw2}(λ)−μ_{aw}(λ) multiplied by the proportionality constant α.” The volume fraction of the component can be obtained by treating μ′_{ag}(λ) as one physical property using Equation (6) in a range in which μ′_{ag}(λ)v_{g} is linear with respect to v_{g} (i.e., μ′_{ag}(′) is not changed according to v_{g}).

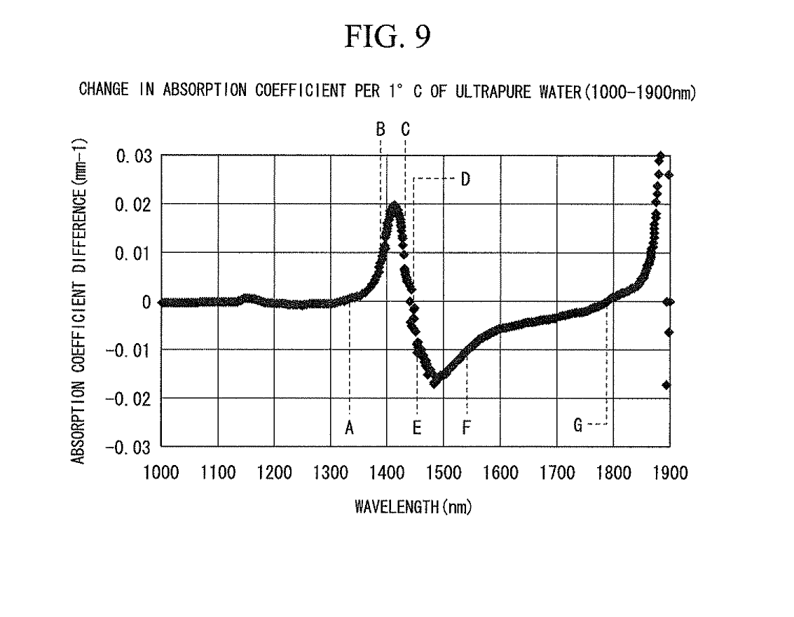

Hereinafter, an example of a combination of measurement wavelengths in the invention is illustrated. First, a graph used for selection of the combination of the measurement wavelengths in the invention is shown in FIG. 9. FIG. 9 shows a change of the absorption coefficient per 1° C. of ultrapure water in each wavelength. In the following description, a wavelength of 1300 nm in which a change amount of an absorption coefficient of the water due to a change in water temperature in the graph is substantially zero is a wavelength A, 1430 nm is a wavelength D, and 1789 nm is a wavelength G. Also, a wavelength 1390 nm in which the change amount of the absorption coefficient of the water due to the change in the water temperature is +0.01 (mm⁻¹) is a wavelength B, and 1420 nm is a wavelength C. Further, a wavelength 1450 nm in which the change amount of the absorption coefficient of the water due to the change in the water temperature is −0.01 (mm⁻¹) is a wavelength E, and 1588 nm is a wavelength F.

Wavelength Combination Example 1 in the invention will be described.

First, the absorption coefficient (μₐ(λ1)) in the first wavelength and the absorption coefficient (μₐ(λ2)) in the second wavelength are measured, and an absorption coefficient (λ_{aw}(λ1)) of the water in the first wavelength, an absorption coefficient (μ_{aw}(λ2)) of the water in the second wavelength, an absorption coefficient (μ_{ag}(λ1)) of the glucose in the first wavelength, and an absorption coefficient (λ_{ag}(λ2)) of the glucose in the second wavelength are referenced as the combination of measurement wavelengths in the present embodiment. A simultaneous equation (Equation 1 and Equation 2) is applied to obtain a volume fraction (V_{g}1) of unknown glucose and a volume fraction (V_{w}1) of the water based on the absorption coefficients (μₐ(λ1), μₐ(λ2), μ_{aw}(λ1), μ_{aw}(λ2), μ_{ag}(λ1) and μ_{ag}(λ2)).

μₐ(λ1)−μₐ(λ2)=(μ_{aw}(λ1)−μ_{aw}(λ2))V_{w}+(μ_{ag}(λ1)−μ_{ag}(λ2))V_{g} (Equation 1)

V_{g}1+V_{w}1=1 (Equation 2)

An example in which lights having the wavelength E and the wavelength F in which the change amount of the absorption coefficient in FIG. 9 becomes −0.01 (mm⁻¹) are combined is shown as an example of a combination of the first wavelength and the second wavelength. Also, an example in which lights having the wavelength B and the wavelength C in which the change amount of the absorption coefficient in FIG. 9 becomes +0.01 (mm⁻¹) are combined is shown.

Next, Wavelength Combination Example 2 in the invention will be described. A process of measuring an absorption coefficient (μₐ(λ3)) of the glucose solution in a third wavelength in which the change amount of the absorption coefficient of the water due to the change in the water temperature is substantially zero using light having the third wavelength is further included. The absorption coefficient (μ_{aw}(λ3)) of the water in the third wavelength and the absorption coefficient (μ_{ag}(λ3)) of the glucose in the third wavelength are applied together to Equation 3, and a simultaneous equation is formed using any of Equation 3, Equation 1, and Equation 2. Thus, a volume fraction (V_{g}1) of unknown glucose and a volume fraction (V_{w}1) of the water can be obtained.

μₐ(λ3)=(μ_{aw}(λ3)×V_{w}1)+(μ_{ag}(λ3)×V_{g}1) (Equation 3)

An example is shown in which light having the w(Equation 3) the wavelength D, and the wavelength G in which the change amount of the absorption coefficient in FIG. 9 becomes substantially zero is used as the light having the third wavelength.

Next, Wavelength Combination Example 3 in the invention will be described. A process of causing a set of lights having the fourth and fifth different wavelengths in which absolute values of the change amounts of the absorption coefficient of the water due to the change in the water temperature are substantially the same and the change amounts have opposite, i.e., positive and negative, signs to be incident on the glucose solution, and measuring the absorption coefficient (μₐ(λ4)) in the fourth wavelength and the absorption coefficient (μₐ(λ5)) in the fifth wavelength in the glucose solution is included.

An absorption coefficient (μ_{aw}(λ4)) of the water in the fourth wavelength, an absorption coefficient (μ_{aw}(λ5)) of the water in the fifth wavelength, an absorption coefficient (μ_{ag}(λ4)) of the glucose in the fourth wavelength, and an absorption coefficient (μ_{ag}(λ5)) of the glucose in the fifth wavelength are referenced. A simultaneous equation (Equation 4 and Equation 5) is applied to obtain a volume fraction (V_{g}2) of the unknown glucose and a volume fraction (V_{w}2) of the water based on the absorption coefficients (μₐ(λ4), μₐ(λ5), μ_{aw}(λ4), μ_{aw}(λ5), μ_{ag}(λ4), and μ_{ag}(λ5)).

μₐ(λ4)+μₐ(λ5)=(μ_{aw}(λ4)+μ_{aw}(λ5))V_{w}2+(μ_{ag}(λ4)+μ_{ag}(λ5))V_{g}2 (Equation 4)

V_{g}2+V_{w}2=1 (Equation 5)

Examples of the combination of the light having the fourth wavelength and the light having the fifth wavelength include, for example, a combination of the light having to the wavelength B in which the change amount of the absorption coefficient is +0.01 (mm⁻¹) and the light having the wavelength E in which the change amount of the absorption coefficient is −0.01 (mm⁻¹), a combination of the lights having the wavelength C and the wavelength F, a combination of the lights having the wavelength B and the wavelength F, and a combination of the lights having the wavelength C and the wavelength E.

Next, Wavelength Combination Example 4 in the invention will be described. A process of measuring an absorption coefficient (μₐ(λ6)) of the glucose solution in a sixth wavelength in which the change amount of the absorption coefficient of the water due to the change in the water temperature is substantially zero using light having the sixth wavelength is further included.

An absorption coefficient (μ_{aw}(λ6)) of the water in the sixth wavelength and an absorption coefficient (μ_{ag}(λ6)) of the glucose in the sixth wavelength are applied together to Equation 6, and a simultaneous equation is formed using any of Equation 6, Equation 4 and Equation 5. Accordingly, a volume fraction (V_{g}2) of the unknown glucose and a volume fraction (V_{w}2) of the water can be obtained.

μₐ(λ6)=(μ_{aw}(λ6)×V_{w}2)+(μ_{ag}(λ6)×V_{g}2) (Equation 6)

An example in which the light having the wavelength A, the wavelength D, and the wavelength G in which the change amount of the absorption coefficient in FIG. 9 becomes substantially zero is used as the light having the sixth wavelength is shown.

Light of a flat region in which the change amount in the wavelengths of 1000 to 1300 nm shown in the graph of FIG. 9 is substantially zero may be used as the light having the wavelength in which the change amount of the absorption coefficient of the water due to the change in the water temperature is substantially zero.

Hereinafter, variations of the measurement procedure (the concentration measurement method) of the invention will be described. However, the invention is not limited to such procedures.

Other Concentration Measurement Method 1 in the invention will be described.

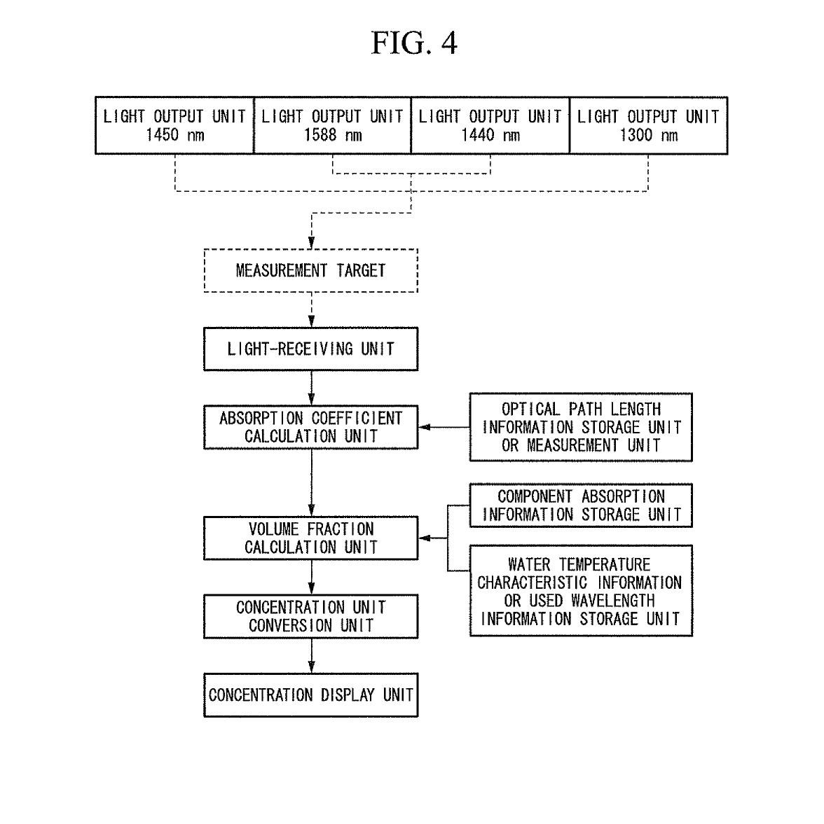

FIG. 4 is a flowchart showing another example of the concentration measurement method of the invention.

In the present embodiment, data of two wavelengths is applied to Equation 1 described above and two resultant equations are used to obtain a volume fraction. In this case, it is necessary to irradiate four lights having different wavelengths to the measurement target (the sample) using a light source. A pair of lights having a wavelength of 1450 nm and a wavelength of 1588 nm and a pair of lights of wavelengths of 1440 nm and 1300 nm are used. The pair of wavelengths of light are selected so that temperature change amounts of the absorption coefficient of the water are the same. Other parts are the same as those in the procedure shown in FIG. 2.

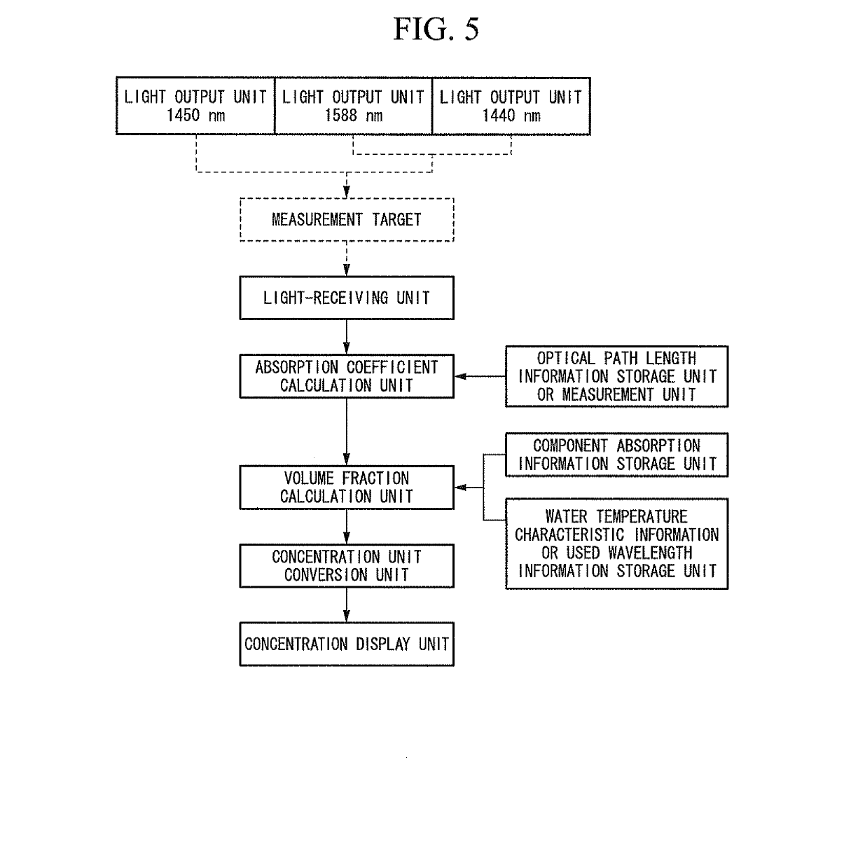

Next, Other Concentration Measurement Method 2 in the invention will be described. FIG. 5 is a flowchart showing another example of the concentration measurement method of the invention.

In the present embodiment, the temperature change of the absorption coefficient of the water is substantially zero in the light having a wavelength of 1440 nm and the light having a wavelength of 1300 nm among the two wavelength pairs shown in the embodiment shown in FIG. 4. Accordingly, even when only light having such wavelengths is used instead of using a difference between the wavelength pairs, there is almost no influence of a change in water temperature. Therefore, a high-accuracy measurement is possible. In this embodiment, a configuration using the light having the wavelength of 1450 nm, light having a wavelength of 1588 nm and the light having the wavelength of 1440 nm is shown. Other parts are the same as those in the procedure shown in FIG. 2.

Hereinafter, variations of the concentration measurement apparatus of the invention will be described. However, the invention is not limited to such configurations.

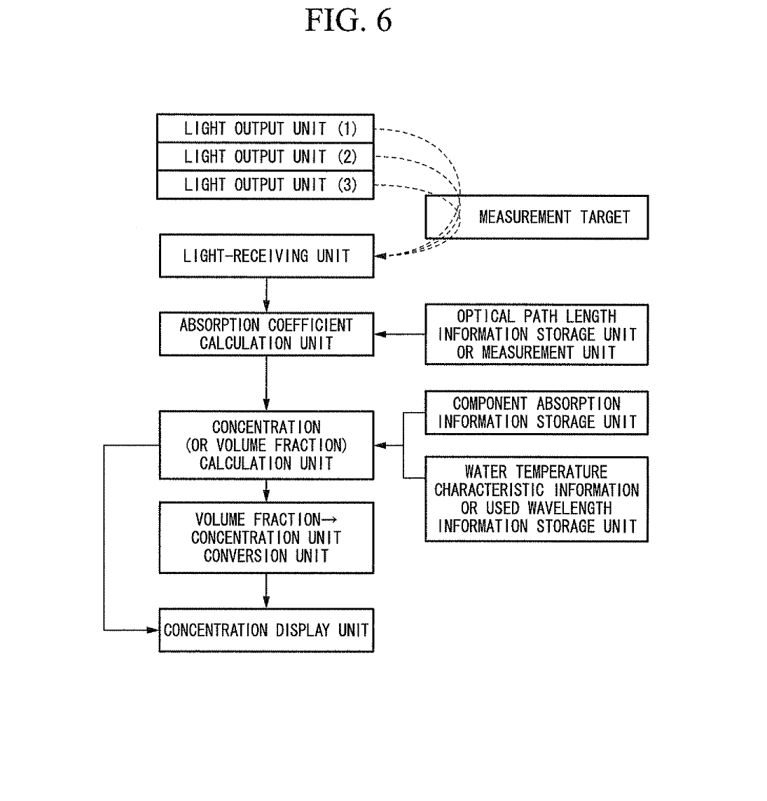

Other Concentration Measurement Apparatus 1 in the invention will be described. FIG. 6 is a block diagram showing another example of the concentration measurement apparatus of the invention.

In the concentration measurement apparatus shown in the present embodiment, three light output units (light sources) for irradiating lights having different wavelengths are included, the lights irradiated from the respective light sources are reflected by a measurement target (a sample), and the reflected lights (backscattered lights) are received. The concentration measurement apparatus in the present embodiment may be suitably applied when the sample has light reflectivity in comparison with the configuration in which the transmitted light that is transmitted through the measurement target (the sample) shown in FIG. 1 is received. The concentration measurement apparatus in the present embodiment may be realized by forming an optical reflective film on one surface of the cell into which the sample has been put.

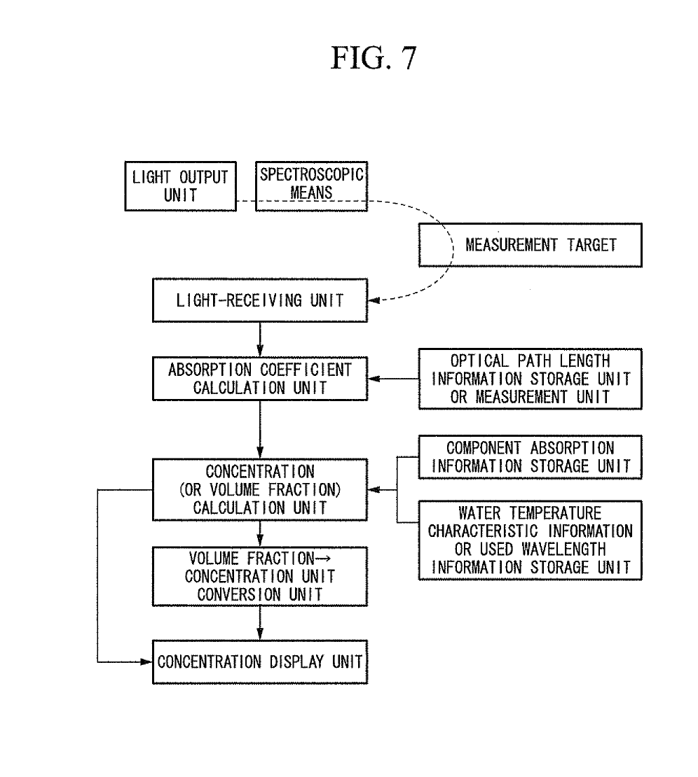

Next, Other Concentration Measurement Apparatus 2 in the invention will be described. FIG. 7 is a block diagram showing another example of the concentration measurement apparatus of the invention.

In the concentration measurement apparatus shown in the present embodiment, light output from a light output unit (a light source), which irradiates light including a plurality of wavelengths, for example, white light, is divided into lights having specific wavelengths by a spectroscopic means, and the divided lights are incident on a measurement target (a sample) to measure the absorption coefficient. For example, a spectroscope using a prism or a diffraction grating may be used as the spectroscopic means.

Although the embodiments of the invention have been described above with reference to the drawings, concrete configurations are not limited to the above-described configurations, and several designs and modifications may be made without departing from the scope and spirit of the invention.

For example, while the absorption coefficients are subtracted from each other on the left side of the equation to obtain the volume fraction shown in Equation 1, the volume fraction may be similarly obtained by conversely adding the absorption coefficients.

For example, the volume fraction and the absorption coefficient of the water and the volume fraction and the absorption coefficient of glucose may be replaced with a molar concentration and a molar extinction coefficient of water and a molar concentration and a molar extinction coefficient of the glucose, respectively. When the replacement is performed, an equation corresponding to Equation 1 becomes Equation 12

μₐ(λ1)−μₐ(λ2)=(ε_{w}(λ1)−ε_{w}(λ2))C_{w}+(ε_{g}(λ1)−ε_{g}(λ2))C_{g} (Equation 12)

Further, in Equation 12

μₐ(λ1): absorption coefficient of the solution in the wavelength λ1

μₐ(λ2): absorption coefficient of the solution in the wavelength λ2

ε_{w}(λ1): molar extinction coefficient of the water in the wavelength λ1

ε_{w}(λ2): molar extinction coefficient of the water in the wavelength λ2

ε_{g}(λ1): molar extinction coefficient of the solute in the wavelength λ1

ε_{g}(λ2): molar extinction coefficient of the solute in the wavelength λ2

C_{w}: molar concentration of the water

C_{g}: molar concentration of the solute

In the above-described embodiment, although the measurement of the volume fraction corresponding to the temperature change in the solution prepared by dissolving one component, the solute (e.g., glucose), in the water has been shown, the invention may be similarly applied to an embodiment in which volume fractions of respective components corresponding to a temperature change in a solution prepared by dissolving two or more solutes (e.g., glucose, sodium chloride, and the like) in the water are obtained.

For example, the skin of the palm of a person may be used as an observation to target in another apparatus for measuring concentrations of respective components between any solvent and solute interacting with each other as target components.

In the above-described embodiment, although the measurement is performed using transmitted light that is transmitted through the sample, the measurement may be performed using reflected light that is reflected by and transmitted through the sample. In an example of the measurement using the reflected light, for example, light having a predetermined wavelength is irradiated from an irradiation unit (a light source) toward skin (an observation target) of a person. The irradiation unit may irradiate the light to the skin.

A plurality of lights irradiated by the irradiation unit include light having a wavelength in which orthogonality of an absorption spectrum distribution of each of main components of the skin increases, that is, a maximum value of an absorption spectrum of a specific component in a certain main component among the main components of the skin is greatly different from maximum values of absorption spectra of other components. It is possible to receive light (measurement light) obtained by backscattering of the light due to the skin and measure a concentration of the glucose contained in the body fluid of the skin based on the received light.

100 . . . concentration measurement apparatus, 102 . . . storage unit, 103 . . . display unit, 104 . . . measurement light intensity acquisition unit, 105 . . . irradiation unit (light source), 106 . . . light-receiving unit, 110 . . . glass cell.

1. A method of measuring, a concentration of a solute in a solution prepared by dissolving the solute in solvent by absorptiometry, the method comprising:
irradiating a set of lights having a first wavelength and a second wavelength, the first wavelength and the second wavelength being different, change amounts of absorption coefficients of the solvent due to a change of solvent temperature at the first wavelength and the second wavelength being substantially same;
measuring an absorption coefficient of the solvent at the first wavelength and an absorption coefficient of the solvent at the second wavelength;
referencing an absorption coefficient of the solvent at the first wavelength and an absorption coefficient of the solvent at the second wavelength;
referencing an absorption coefficient of the solute at the first wavelength and an absorption coefficient of the solute at the second wavelength; and
applying the following simultaneous equation (1 and 2) to obtain a volume fraction of an unknown solute and a volume fraction of the solvent,
μₐ(λ1)−μₐ(λ2)=(μ_{aw}(λ1)−μ_{aw}(λ2))V_{w}+(μ_{ag}(λ1)−μ_{ag}(λ2))V_{g} (1)
V_{g}1+V_{w}1=1 (2)
where:
μₐ(λ1) is the absorption coefficient at the first wavelength of the solution;
μₐ(λ2) is the absorption coefficient at the second wavelength of the solution;
μ_{aw}(λ1) is the absorption coefficient of the solvent at the first wavelength;
μ_{aw}(λ2) is the absorption coefficient of the solvent at the second wavelength;
μ_{ag}(λ1) is the absorption coefficient of the solute at the first wavelength;
μ_{ag}(λ2) is the absorption coefficient of the solute at the second wavelength;
V_{w}1 is the volume fraction of the solvent; and
V_{g}1 is the volume fraction of the unknown solute.

2. The method according to claim 1, the solvent being water.

3. The method according to claim 1, further comprising:
measuring an absorption coefficient of the solution at a third wavelength using light having the third wavelength, change amount of an absorption coefficient of the solvent at the third wavelength due to a change of the solvent temperature being substantially zero;
the absorption coefficient of the solvent at the third wavelength and an absorption coefficient of the solute at the third wavelength are applied together to Equation (3) and a simultaneous equation being formed using arbitrary of the following Equation (3), Equation (1) and Equation (2) to obtain a volume fraction of the unknown solute and a volume fraction of the solvent,
μₐ(λ3)=(μ_{aw}(λ3)×V_{w}1)+(μ_{ag}(λ3)×V_{g}1) (3)
where:
μₐ(λ3) is the absorption coefficient of the solution at the third wavelength;
μ_{aw}(λ3) is the absorption coefficient of the solvent at the third wavelength;
μ_{ag}(λ3) is the absorption coefficient of the solute at the third wavelength;
V_{w}1 is the volume fraction of the solvent; and
V_{g}1 is the volume fraction of the unknown solute.

4. A method of measuring a concentration of a solute in a solution prepared by dissolving the solute in solvent by absorptiometry, the method comprising:
irradiating a set of lights having a fourth wavelength and a fifth wavelength, the fourth wavelength and the fifth wavelength being different;
absolute values of change amounts of absorption coefficients of the solvent due to a change of solvent temperature at the fourth wavelength and the fifth wavelength are substantially same and values of the change amounts at the fourth wavelength and the fifth wavelength being opposite, i.e., positive and negative, signs;
measuring an absorption coefficient in the fourth wavelength and an absorption coefficient in the fifth wavelength of the solution;
referencing an absorption coefficient of the solvent at the fourth wavelength and an absorption coefficient of the solvent at the fifth wavelength;
referencing an absorption coefficient of the solute at the fourth wavelength and an absorption coefficient of the solute at the fifth wavelength; and
applying the following simultaneous equation (4 and 5) to obtain a volume fraction of an unknown solute and a volume fraction of the solvent,
μₐ(λ4)+μₐ(λ5)=(μ_{aw}(λ4)+μ_{aw}(λ5))V_{w}2+(μ_{ag}(λ4)+μ_{ag}(λ5))V_{g}2 (4)
V_{g}2+V_{w}2=1 (5)
where:
μₐ(λ4) is the absorption coefficient at the fourth wavelength of the solution;
μₐ(λ5) is the absorption coefficient at the fifth wavelength of the solution;
μ_{aw}(λ4) is the absorption coefficient of the solvent at the fourth wavelength;
μ_{aw}(λ5) is the absorption coefficient of the solvent at the fifth wavelength;
μ_{ag}(λ4) is the absorption coefficient of the solute at the fourth wavelength;
μ_{ag}(λ5) is the absorption coefficient of the solute at the fifth wavelength;
V_{g}2 is the volume fraction of the unknown solute; and
V_{w}2 is the volume fraction of the solvent.

5. The method according to claim 4, the solvent being water.

6. The method according to claim 3, further comprising:
measuring an absorption coefficient of the solution at a sixth wavelength using light having the sixth wavelength, change amount of an absorption coefficient of the solvent at the sixth wavelength due to a change of the solvent temperature being substantially zero,
the absorption coefficient of the solvent at the sixth wavelength and an absorption coefficient of the solute at the sixth wavelength being applied together to Equation (6) and a simultaneous equation being formed using arbitrary of the following Equation (6), Equation (4) and Equation (5) to obtain a volume fraction (V_{g}2) of the unknown solute and a volume fraction (V_{w}2) of the solvent,
μₐ(λ6)=(μ_{aw}(λ6)×V_{w}2)+(μ_{ag}(λ6)×V_{g}2) (6)
where:
μₐ(λ6) is the absorption coefficient of the solution at the sixth wavelength;
μ_{aw}(λ6) is the absorption coefficient of the solvent at the sixth wavelength;
μ_{ag}(λ6) is the absorption coefficient of the solute at the sixth wavelength;
V_{g}2 is the volume fraction of the unknown solute; and
V_{w}2 is the volume fraction of the solvent.

7. A concentration measurement apparatus comprising:
a light source capable of irradiating a set of lights having a seventh wavelength and eighth wavelength, the seventh wavelength and the eighth wavelength being different, change amounts of absorption coefficients of solvent of a solution due to a change of solvent temperature are substantially same;
a storage unit capable of storing an absorption coefficient of the solvent at the seventh wavelength, an absorption coefficient of the solvent at the eighth wavelength, an absorption coefficient of solute of the solution at the seventh wavelength, and an absorption coefficient of the solute at the eighth wavelength; and
a calculation unit capable of calculating a volume fraction of the solute and a volume fraction of the solvent of the solution based on the absorption coefficients.

8. A concentration measurement apparatus comprising:
the solvent being water.

9. The concentration measurement apparatus according to claim 7, the seventh wavelength being in a range from 1440 nm to 1480 nm, and the eighth wavelength being in a range from 1500 to 1800 nm.

10. The concentration measurement apparatus according to claim 7, the light source being further capable of irradiating light having a ninth wavelength, change amount of the absorption coefficient of the solvent due to the change to the solvent temperature being substantially zero.

11. The concentration measurement apparatus according to claim 10, the ninth wavelength being in a range of any one of 1789±10 nm, 1440±10 nm, and 1000 nm to 1300 nm.

12. The concentration measurement apparatus according to claim 7, the light source including a spectrometer that divides light having a plurality of wavelengths to a light having the seventh wavelength and a light having the eighth wavelength.

13. A concentration measurement apparatus comprising:
a light source capable of irradiating a set of lights having tenth wavelength and eleventh wavelength, the tenth wavelength and the eleventh wavelength being different, absolute values of change amounts of absorption coefficients of a solvent due to a change of solvent temperature at the tenth wavelength and the eleventh wavelength being substantially same and values of the change amounts being opposite, i.e., positive and negative, signs;
a storage unit capable of storing an absorption coefficient of the solvent at the tenth wavelength, an absorption coefficient of the solvent at the eleventh wavelength, an absorption coefficient of solute of solution at the tenth wavelength, and an absorption coefficient of the solute at the eleventh wavelength; and
a calculation unit capable of calculating a volume fraction of the solute and a volume fraction of the solvent of the solution based on the absorption coefficients.

14. The concentration measurement apparatus according to claim 13, the solvent being water.

15. The concentration measurement apparatus according to claim 13, the tenth wavelength being in a range from 1440 nm to 1480 nm, and the eleventh wavelength being in a range from 1500 nm to 1800 nm.

16. The concentration measurement apparatus according to claim 13, the light source being further capable of irradiating light having a twelfth wavelength, change amount of absorption coefficient of the solvent due to a change of the solvent temperature being substantially zero.

17. The concentration measurement apparatus according to claim 16, the twelfth wavelength being in a range of any one of 1789±10 nm, 1440±10 nm, and 1000 nm to 1300 nm.

18. The concentration measurement apparatus according to claim 13, the light source including a spectrometer that divides light having a plurality of wavelengths to a light having the tenth wavelength and a light having the eleventh wavelength.

19. The concentration measurement apparatus according to claim 7, the solute being glucose, and the solution being a glucose solution.
